(19) United States
(12) Patent Application Publication
(10) Pub. No.: US 2003/0234080 A1
(43) Pub. Date: Dec. 25, 2003

(54) Compact disc labeling apparatus

(76) Inventor: Joseph Sandor, Corona Del Mar, CA (US)

Correspondence Address: Averill & Varn, 8244 Painter Ave., Whittier, CA, 90602, US

(21) Appl. No.: 09/906,906

(22) Filed: Jul. 18, 2001

Related U.S. Application Data
(63) Continuation-in-part of application No. 09/573,397, filed on May 18, 2000, now Pat. No. 6,516,852.

(51) Int. Cl. B32B 1/00; B32B 31/00

(52) U.S. Cl. 156/391; 156/556; 156/580

(57) ABSTRACT

A label applying apparatus for concentrically applying annular labels (having adhesive on one side) to compact discs. The apparatus is an insert which is dimensioned to be mounted in a lid portion of a conventional jewel case having cover and base portions capable of hinging relative to each other between open and closed positions. The insert has a central press surface to which an annular label may be temporarily retained, and peripheral shoulders which releasably engage guide tabs found on the cover portion. When the cover and base portions are hinged to the closed position, the annular label and the compact disc are concentrically aligned and joined together in a bonding relationship. Furthermore, the press surface preferably has an annular configuration with a convex-curvilinear cross-section which operates to evenly apply an annular label in a rolling manner.

### CROSS REFERENCE TO RELATED APPLICATIONS

This application is a continuation-in-part of applicant's application Ser. No. 09/573,397 filed May 18, 2000.

### BACKGROUND OF THE INVENTION

The field of the invention pertains to labeling devices. The invention relates more particularly to an apparatus for labeling optical storage discs, i.e. compact discs, with adhesive labels, wherein the apparatus is an insert dimensioned to fit within and used in conjunction with a conventional jewel case used to package and store such compact discs.

Optical storage discs, more commonly known as compact discs (“CD”s), are used for computer, audio, video, and other applications involving electro-optically recorded and retrievable digital information. In particular, writeable compact discs, such as CD-R and CD-RW, have grown in popularity and usage by enabling users to record their own digitized music, video, data, and other information. With this increased use has grown a need to label these discs once they have been produced and recorded with content. This is because writeable compact discs have no apparent visual method for uniquely identifying a compact disc or determining its contents. While one method of compact disc labeling utilizes a silk-screening or similar printing process to imprint a graphic image or other pre-printed material on the top surface of a disc, this method is typically employed by large-scale manufacturers and would be too impractical for individuals desiring single or small run labeling applications.

Another known method employs annular self-adhesive labels having a gummed adhesive on one side and a non-adhesive markable surface on the other. The difficulty presented by adhesive labels is in accurately centering them on the compact discs. Proper centering is essential for achieving a high-speed, steady-state spin, which is necessary to ensure proper reading and transfer of the digital information stored thereon. Moreover, unbalanced spinning of the compact disc can cause damage to the motor of the compact disc player device. To this end, various types of devices have been developed in an effort to properly center adhesive labels when fixedly applying them to the non-reading side of compact discs.

In particular, many prior art labeling devices feature a vertically operating piston-type configuration wherein a piston/plunger operates to combine an annular label and a compact disc together along a central axis of motion. A representative example of such an arrangement is shown in U.S. Pat. No. 5,951,819, which discloses a label applying apparatus having a base which supports a label, and a plunger which supports a compact disc. The plunger is positioned within a center opening of the base and internally supported by a biasing spring against the base. In use, the plunger is telescopically compressed and urged into the center opening of the base against the action of the spring to join the label with the compact disc.

Perhaps the greatest problem with these types of adhesive labeling devices exemplified by the '819 patent is the amount of space required to store such devices. In particular, the relatively large footprint and bulk of these prior art devices may pose a burden on users when attempting to conveniently and inconspicuously store the device away when not in use. The typical piston-type configuration requires and effectively occupies a cylindrical-shaped volume, which often cannot be stored in an easily accessible location near where compact discs are stored, e.g. a compact disc rack. Because such adhesive labeling devices are typically for home and personal use by individual users, and not for industrial or manufacturing applications, it would be advantageous to provide a compact labeling device with a small footprint and capable of being kept together with other compact discs for easy access.

Furthermore, because the size and number of moving components of these prior art labeling devices are relatively large in relation to the compact discs themselves, manufacture and assembly of such prior art labeling devices may come at a high cost. Thus, it can be further appreciated that a smaller, more compact device having a minimal number of moving parts would give such compact labeling devices greater consumer appeal to a larger number of users wishing to label their own compact discs.

### BRIEF SUMMARY OF THE INVENTION

It is therefore an object of the present invention to provide a simple and efficient optical disc labeling apparatus capable of concentrically adhering an annular label to a compact disc.

It is a further object of the present invention to provide an optical disc labeling apparatus which operates in conjunction with a conventional jewel case to apply an annular label to a compact disc by hinging the cover and base portions of the jewel case relative to each other.

It is a still further object of the present invention to provide an optical disc labeling apparatus dimensioned to be insertably mounted in a conventional compact disc jewel case whereby convenient and space-efficient storage of the apparatus can be realized.

Another object of the present invention is to provide an optical disc labeling apparatus which may be insertably mounted in a cover portion of a jewel case by engaging the guide tabs thereof.

And still another object of the present invention is to provide a cost-effective optical disc labeling apparatus having a integrally-formed unitary construction capable of being mass-produced by conventional manufacturing methods.

The present invention is for a jewel case insert for concentrically applying an annular label with a self-adhesive side to a compact disc. The jewel case insert is designed for use with a conventional jewel case of the type having first and second platforms hingedly connected to each other to hinge between open and closed positions. The first platform, or base portion, has a compact disc support surface and means for releasably mounting a compact disc thereon. And the second platform, or cover portion, has an inner surface which confronts the compact disc support surface when in the closed position, and a plurality of guide tabs which extend inwardly in spaced relation to the inner surface. The jewel case insert comprises a press portion having a press surface, and label retaining means for temporarily retaining an annular label against the press surface with the self-adhesive side up. Furthermore, the jewel case insert also comprises shoulder means connected to the press portion for releasably engaging the plurality of guide tabs. In this manner, the shoulder means maintains the press portion adjacent the inner surface of the second platform with the press surface facing up. When the first and second platforms are hinged to the closed position, a temporarily retained annular label is concentrically aligned with a releasably mounted compact disc and the press surface abuts the annular label against the compact disc to transfer it thereto.

### BRIEF DESCRIPTION OF THE DRAWINGS

FIG. 1 is a perspective view of the compact disc labeling apparatus in the open position, with a compact disc and annular label mounted thereon.

FIG. 2 is a perspective view of the compact disc labeling apparatus in the closed position illustrating the compact and slim configuration of the compact disc labeling apparatus.

FIG. 3 is a top view of the compact disc labeling apparatus shown in FIG. 1 in the open position.

FIG. 4 is a cross-sectional side view of the compact disc labeling apparatus taken along the line 4-4 of FIG. 3.

FIG. 5 is a partly cross-sectional front view of the compact disc labeling apparatus taken along the line 5-5 of FIG. 3.

FIG. 6 is a perspective view of the compact disc labeling apparatus similar to FIG. 1 with the second platform partly cut out to show a radial cross section of the second platform and annular label.

FIG. 7 is an enlarged view of the radial cross-section of the second platform and annular label taken along the circle 7 of FIG. 6.

FIG. 8 is a perspective view of the second platform of the compact disc labeling apparatus embodying a second preferred embodiment of the means for temporarily retaining the annular label.

FIG. 9 is a cross-sectional view of the second platform of the compact disc labeling apparatus taken along the line 9-9 of FIG. 8.

FIG. 10 is a perspective view of the second platform of the compact disc labeling apparatus embodying a third preferred embodiment of the means for temporarily retaining the annular label.

FIG. 11 is a cross-sectional view of the second platform of the compact disc labeling apparatus taken along the line 11-11 of FIG. 10.

FIG. 12 is a perspective view of a jewel case insert mounted in a jewel case shown in an open position.

FIG. 13 is an exploded perspective view of the jewel case insert shown with the notches aligned with the guide tabs of the second platform.

FIG. 14 is a perspective view of the jewel case insert following FIG. 13 with the insert transversely drop-loaded onto the second platform.

FIG. 15 is a perspective view of a bisected jewel case insert illustrating the cross-sectional construction thereof.

FIG. 16 is an enlarged cross-sectional view of the jewel case insert taken along circle 16 of FIG. 15.

### DETAILED DESCRIPTION OF THE PREFERRED EMBODIMENTS

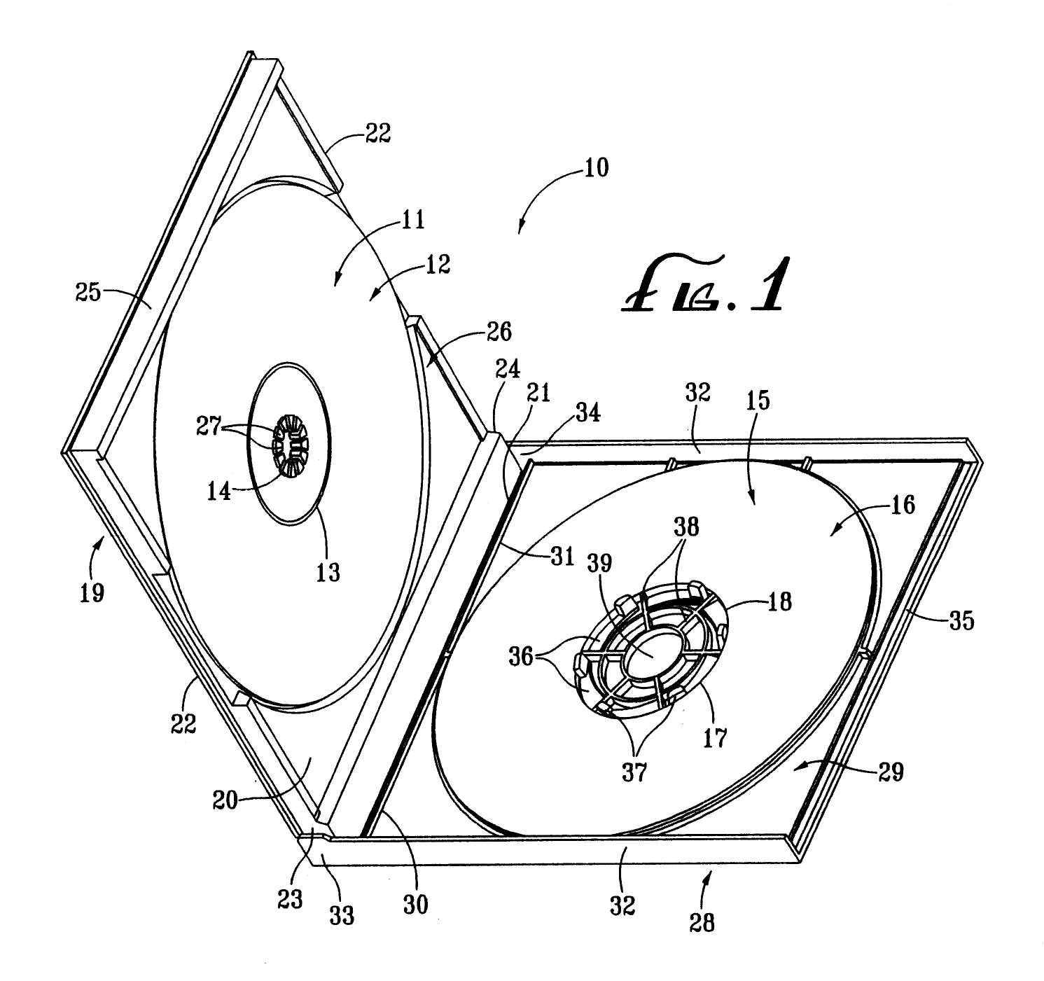

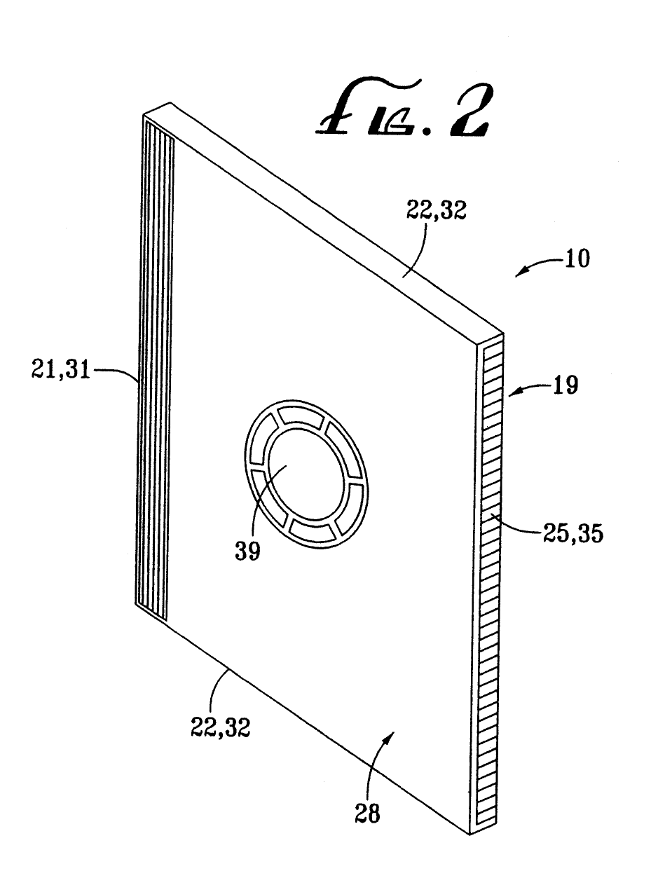

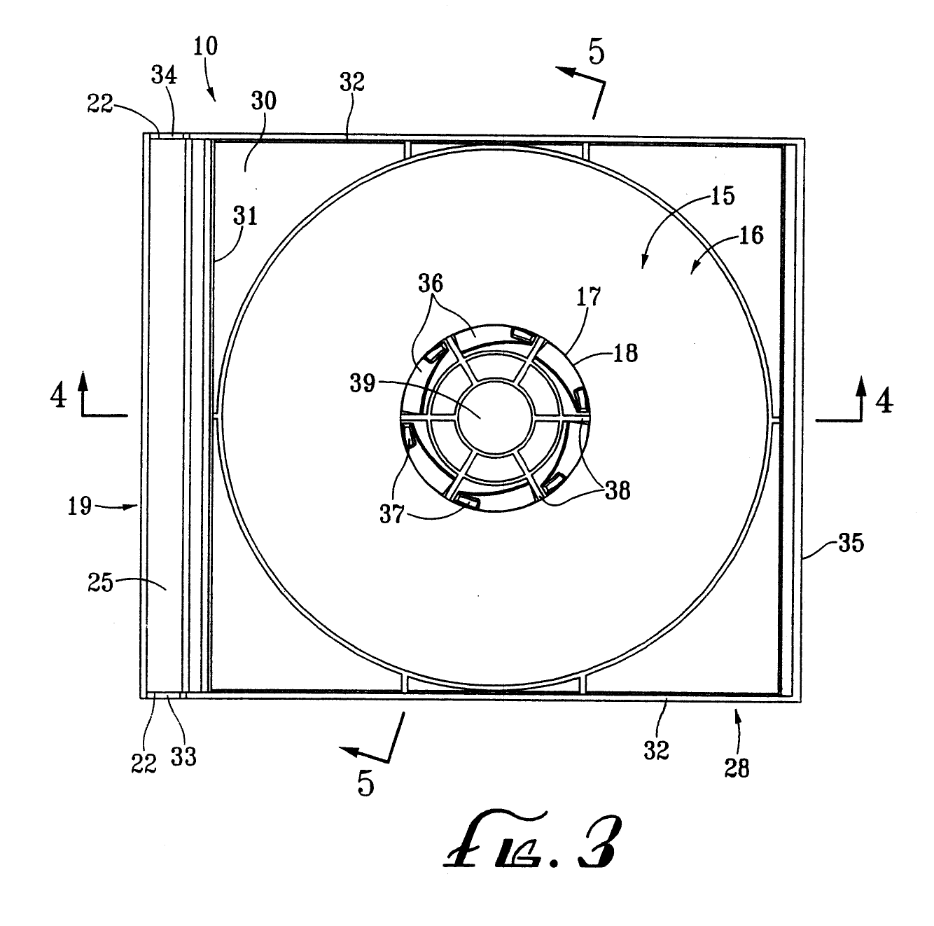

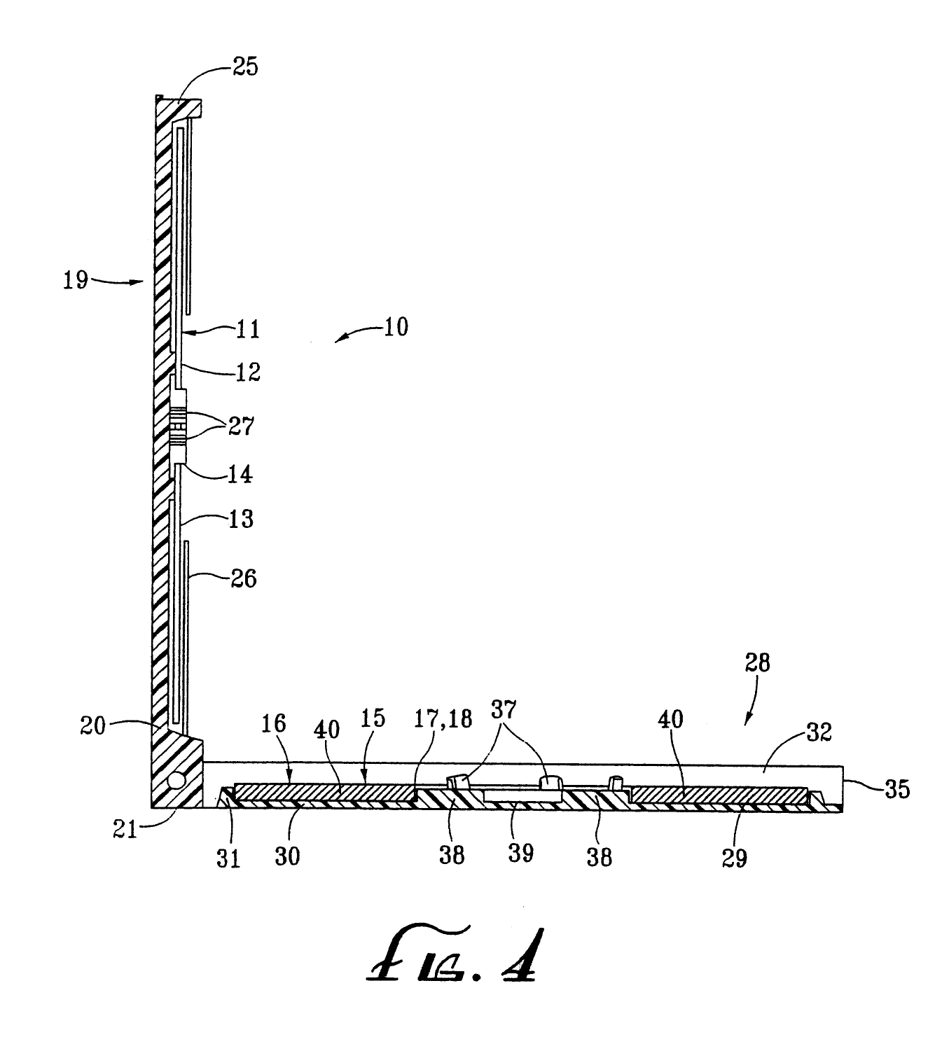

Referring now to the drawings, FIGS. 1-6 show various views of a first preferred embodiment of the compact disc labeling apparatus, generally indicated at reference character 10, for applying a self-adhesive annular label 15 to a compact disc 11. The apparatus 10 has two basic component parts, a first or base platform, generally indicated at reference character 19, and a second or cover platform, generally indicated at reference character 28, which are hinged together to move between an open position (FIGS. 1, 3-6) and a closed position (FIG. 2). The apparatus 10 has similar dimensions, size, and shape as that of conventional “jewel cases” which are commonly used to package and store compact discs. It is appreciated, therefore, that the labeling apparatus 10 has a slim and compact configuration and design which completely and efficiently encloses a compact disc 11 when hinged to the closed position (see FIG. 2). It is notable that conventional jewel cases usually include planar, generally square-shaped base and cover portions which are hinged along a pivot edge in order to allow access to the interior of the case. The base portion of such cases is usually provided with a disc holder having a plurality of centrally located, radially inwardly extending elements which grasp the center opening of the compact disc. And the cover portion of the case usually includes guide tabs which extend inwardly from the side edges to hold printed literature slidably positioned thereon.

It is further notable that the compact disc 11 is made from a plastic material in a manner known in the relevant art, and has a top surface 12 containing a metallic coating, and an opposing bottom surface (not shown) embedded with digitized data. The bottom surface is transparent to permit a laser to encode data thereon, as well as retrievably “read” data therefrom. Furthermore, the compact disc 11 has a centrally located hole 14 utilized for mounting and spin-operation of the compact disc 11. The area immediately surrounding central hole 14 up to a circular edge 13 is a transparent material not for storing data, and can therefore be contacted and handled without the possibility of damaging or losing data. In contrast, the region of the compact disc 11 extending from the circular edge 13 up to the outer edge of the compact disc 11 operates to store data thereon and is considered the readable area.

As can be best seen in FIGS. 1, 5, and 6, the first platform 19 has a generally planar configuration similar to the configuration of a base portion of a jewel case. The first platform 19 comprises a compact disc support surface 26 which extends to and is bounded by four edges: a first outer edge 25, two opposing side edges 22, and a first pivot edge 21 at a first pivot end 20. The compact disc 11 may be mounted on the compact disc support surface 26 with the top surface 12 facing up, i.e. facing away from the securing surface. More particularly, the compact disc 11 is positioned in a recessed portion of the compact disc support surface 26 which is contoured to seat the compact disc 11 therein. In any case, the compact disc 11 is mounted by means for mounting a compact disc which is preferably a disc holder of the type commonly used in jewel cases, as discussed above, having centrally located, radially inwardly extending elements 27. These extending elements 27 partially and snugly extend through and grasp the centrally located hole 14 of the compact disc 11 to effectively mount the compact disc 11 on the compact disc support surface 26.

As can be best seen in FIGS. 1, 3, and 6, the second platform 28 also has a generally planar configuration similar to the configuration of a cover portion of a jewel case. The second platform 28 comprises a label support surface 29 which extends to and is bounded by four edges: a second outer edge 35, two opposing side edges 32, and a second pivot edge 31 at a second pivot end 30. The label support surface 29 functions to seatably support the self-adhesive annular label 15, which has a gummed adhesive side 16 and an opposing, non-adhesive markable side (not shown). Additionally, the self-adhesive annular label 15 has a central hole 17 defined by an inner circumference edge 18 typically having a diameter no less than the circular edge 13 of the compact disc. Preferably, a resiliently biasing element 40 is detachably or fixedly positioned on the label support surface 29 which functions to keep the self-adhesive annular label 15 horizontally oriented. And preferably still, the resiliently biasing element is a foam material 40 which is cut to form fit a recessed portion of the label support surface 29, similar to the recessed portion of the first platform 19.

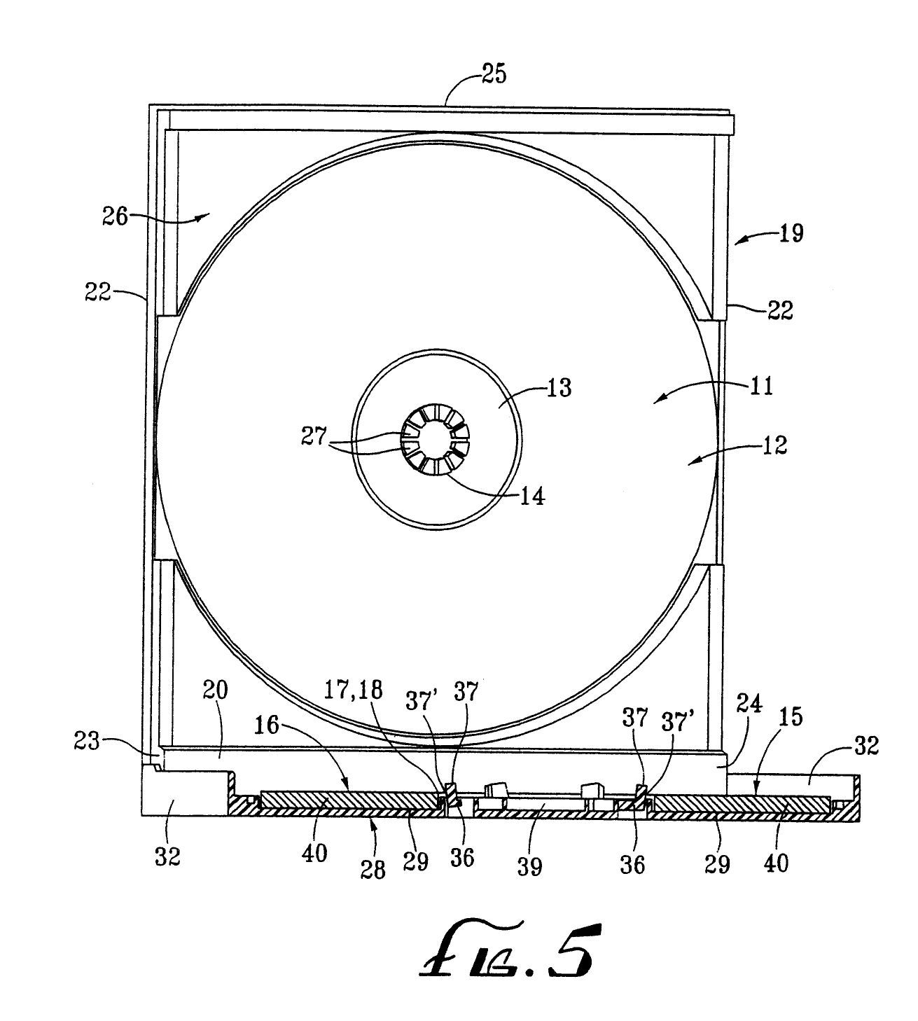

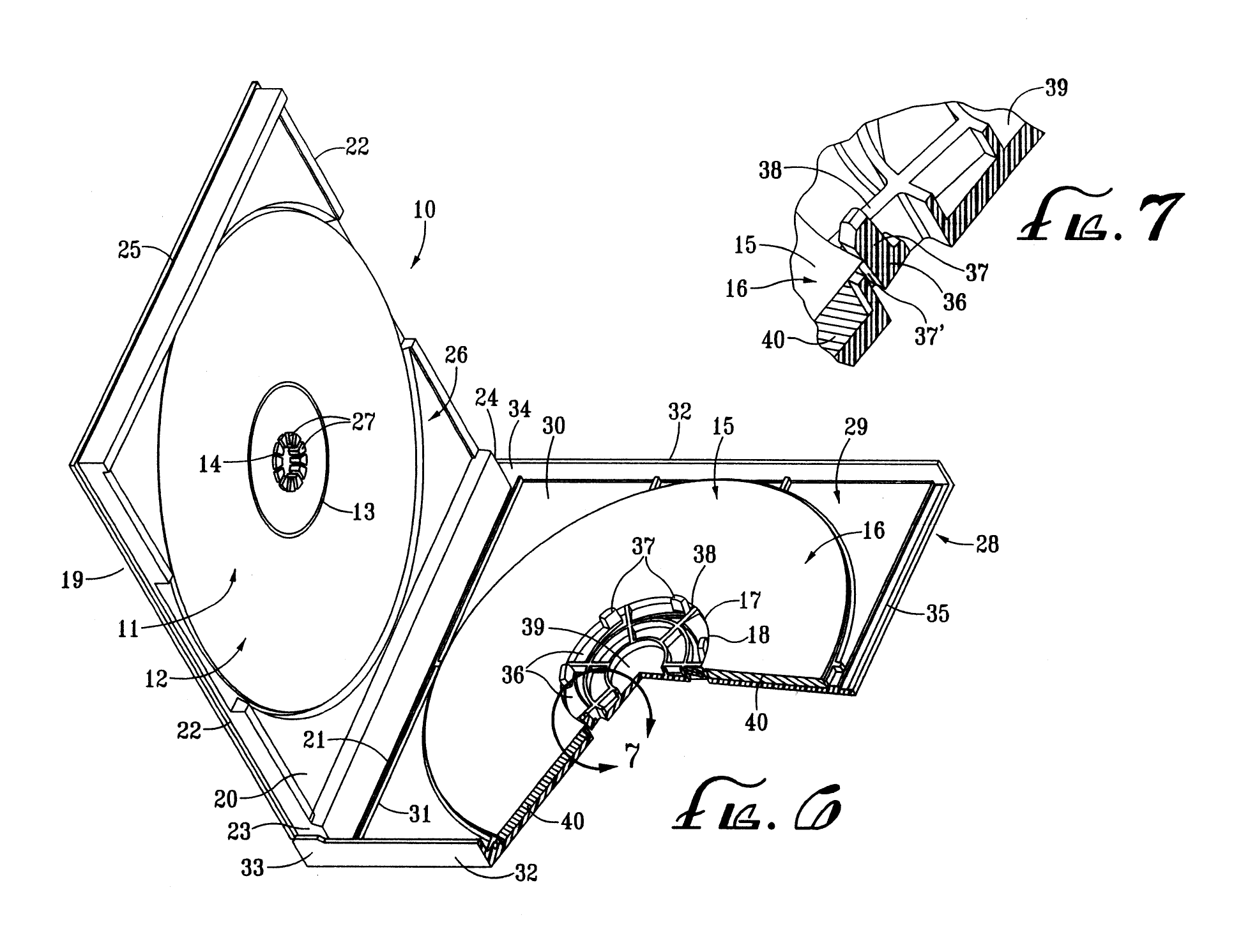

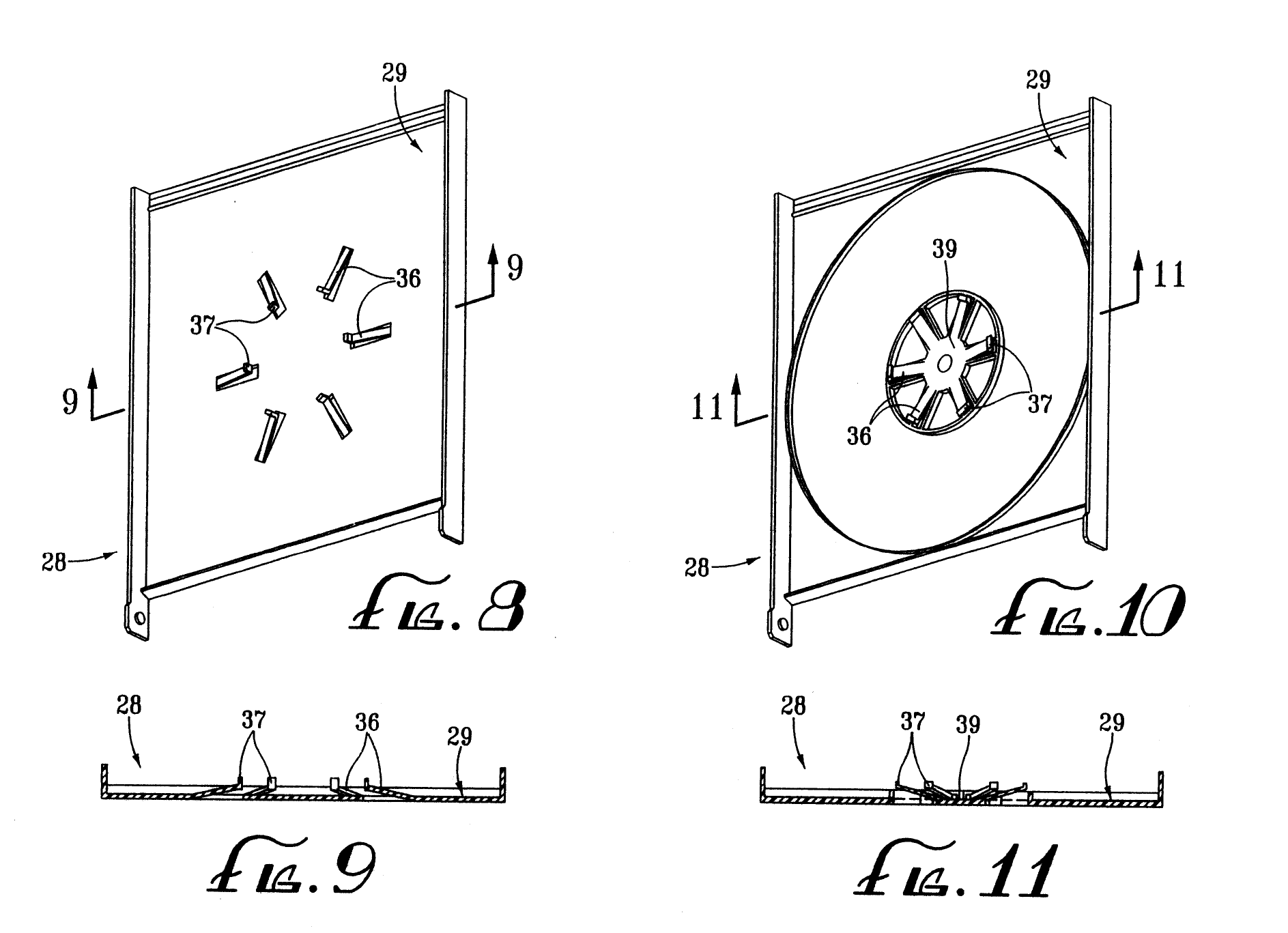

The annular label 14 may be temporarily retained on the label support surface 29, with the adhesive side 16 up and facing away from the label support surface 29, by means for temporarily retaining the annular label 15 on the label support surface 29. Generally, as shown in the figures, the means for temporarily retaining the annular label 15 preferably utilizes at least two fingers 36, located at the center of the label support surface 29. The fingers 36 preferably extend from a fixed end to a suspended end which is adapted to lightly contact the inner circumference edge 18 of the annular label 15 in a resiliently biasing manner. A first preferred embodiment of the means for temporarily retaining can be best seen in FIGS. 1, 3, 6, and 7 having a hub 39 and spoke 38 configuration, with each of the fixed ends of the fingers 36 being transversely secured to a corresponding spoke 38. Alternatively, second and third preferred embodiments of the means for temporarily retaining are shown in FIGS. 8, 9 and 10, 11, respectively. In particular, the fingers 36 of the second preferred embodiment of the means for temporarily retaining are shown in FIGS. 8 and 9 radially inwardly extending in a converging manner with the fixed ends positioned outside the suspended ends. And in FIGS. 10 and 11, the third preferred embodiment of the means for temporarily retaining is shown also having a hub 39 and spoke 38 configuration, with the fingers 36 radially extending outward from the hub 39 in a diverging manner. It is notable that while the third configuration may produce some nicks along the inner circumference edge 18 of the annular label 15 due to the particular movement of its resiliently biasing fingers 36, it would not substantially interfere with the retaining function provided by the fingers 36.

In any case, the fingers 36 shown in the three preferred embodiments preferably also have tabs 37 at its suspended ends which actually effect contact with the inner circumference edge 18 of the annular label 15 along a contact surface 37′ (FIGS. 5 and 7). Preferably, as can be best seen in FIGS. 5 and 7, the top end of the contact surface 37′ of each tab 37 is outwardly angled, such that the inner circumference edge 18 of the annular label 15 is prevented from slipping past the tabs 37. It is notable that the angle of the tabs 37 need only be very slight to sufficiently temporarily retain the annular label 15 thereagainst. Furthermore, it is notable that while the compact disc 11 is considered to be “mounted” on the compact disc support surface 26, the annular label 15 is “temporarily retained” on the label support surface 29, indicating a transitional presence thereon. More particularly, the annular label 15 remains on the label support surface 29 only when in the open position, and is easily disengaged, separated and transferred to the compact disc 11 when in the closed position (see discussion below). In this regard, “temporarily retaining” indicates holding the annular label 15 in a manner which is minimally sufficient to keep it against the label support surface 29, and which easily and simply releases the annular label 15 with little or no effort.

As best shown in FIGS. 1, 4, and 6, the first pivot end 20 of the first platform 19 is hinged to the second pivot end 30 of the second platform 28 along the corresponding pivot edges 21, 31. The pair of side edges 22 of the first platform 19 terminate near the first pivot end 20 at hinge corners 23, 24, and the pair of side edges 32 of the second platform 28 terminate near the second pivot end 30 at hinge plates 33, 34. The hinge plates 33, 34 are pivotally secured to the corresponding hinge corners 23, 24 at pivot joints, which are preferably comprised of pivot pin and hole combinations (not shown).

In this manner, the first and second platforms 19, 29 may hinge relative to each other about their respective pivot ends 20, 30, between an open position and a closed position. Initially, the open position may be obtained by pulling apart the two platforms at the first and second outer edges, 25 and 35, respectively. In the open position, the compact disc 11 may be mounted on the first platform 19 with the top side 12 up, and the annular self-adhesive label 15 may be temporarily retained on the label support surface 29 with the adhesive side 16 up. The two platforms are subsequently hinged together to the closed position (FIG. 2) such that the respective outer edges 25, 26 and side edges 22, 32 of the first and second platforms 19, 28 are again in contact. Preferably, the step of hinging the two platforms 19, 28 together to the closed position entails keeping the second platform 29 steady at a horizontal reference position while hingeably transitioning the first platform 19 alone. This has the advantage of utilizing gravity to help prevent the annular label 15 from curling or otherwise repositioning itself during the transitional hinging step from the open and closed positions. In any case, the means for mounting the compact disc 11 and the means for temporarily retaining the annular label 15 are adapted and indexed in a manner to concentrically align the compact disc 11 and the annular label 15 when in the closed position. Thus, in the closed position, the top side 12 of the compact disc 11 is brought in contact with the adhesive side 16 of the annular label 15 to establish a bonding relationship by virtue of the gummed adhesive. The foam 40 has sufficient thickness so that it is compressed when the first platform 19 is closed against the second platform 28, thereby pressing the adhesive side 16 of the label 15 against the compact disc 11. A preferred foam thickness (uncompressed) is about one-eighth inch, which is preferably compressed about ten percent when the chassis is closed. Once bonded, the two platforms 19, 28 may once again be pulled apart along the first and second outer edges 25, 35, to allow access to the newly labeled compact disc. The difference between the means for mounting the compact disc 11 and the means for temporarily retaining the annular label 15 is apparent in the post-adhesion, reopening process, wherein the stronger grasp of the extending elements 27 of the means for mounting is more than sufficient to overcome the resiliently biasing and retaining contact of the tabs 37 and fingers 36 of the means for temporarily retaining. Thus the now bonded label may easily separate from the label support surface 29 without damaging the inner circumference edge 18 of the annular label 15.

Construction of the compact disc labeling apparatus 10 is preferably made of a durable material, such as impact polystyrene, which would provide greater strength and flexibility than the crystal polystyrene commonly used for conventional jewel cases. The greater durability of impact polystyrene would enable greater number of cycles of repeated use without failure.

In a second embodiment of the compact disc labeling apparatus 10, the second platform 28, as discussed above, may operate as an independent attachment for use with an existing base portion of a conventional jewel case. Furthermore, it is notable that while the label support surface 29 is preferably integrally formed into the second platform 28, it can alternatively be produced as an independent component which is releasably insertable to an existing cover portion of a conventional jewel case, preferably by utilizing the guide tabs of the conventional jewel case, as will be discussed next.

In FIGS. 12-16, a third embodiment of the compact disc labeling apparatus is shown as a jewel case insert, generally indicated at reference character 44. The insert 44 is generally designed for use with a conventional jewel case having a base portion 19′ and a cover portion 28′. Details of a conventional jewel case are best shown in FIG. 12 with both the base portion 19′ and cover portion 28′ having a generally planar, square shaped configuration. The base portion 19′ comprises a compact disc support surface 26′ which extends to and is bounded by four edges: a first outer edge 25′, two opposing side edges 22′, and a first pivot edge 21′ at a first pivot end 20′. As discussed previously, a disc holder mechanism is typically provided with centrally located, radially inwardly extending elements 27′ which releasably mount a compact disc 11 on the compact disc support surface 26′ with the top surface 12 of the compact disc 11 facing up, i.e. facing away from the base portion 19′.

And similar to the base portion 19′, the cover portion 28′ comprises an inner surface 41 which extends to and is bounded by four edges: a second outer edge 35′, two opposing side edges 32′, and a second pivot edge 31′ at a second pivot end 30′. The first pivot end 20′ of the base portion 19′ is hinged to the second pivot end 30′ of the cover portion 28′ along the corresponding pivot edges 21′, 31′. The pair of side edges 22′ of the base portion 19′ terminate near the first pivot end 20′ at hinge corners 23′, 24′, and the pair of side edges 32′ of the cover portion 28′ terminate near the second pivot end 30′ at hinge plates 33″, 34″. The hinge plates 33″, 34″ are pivotally secured to the corresponding hinge corners 23′, 24′of the base portion 19′ via pivot pins 33(a) and 34(a). In this manner, the base portion 19′ and the cover portion 28′ may be pivoted between open and closed positions. It is notable that the cover portion 28′ includes guide tabs 42 which extend inwardly from side edges 32′ in spaced relation to the inner surface 41. Guide channels are thereby formed between the guide tabs 42 and the inner surface 41. The guide tabs 42 are typically used to retain printed literature on the cover portion 28′. As shown in FIG. 12, four guide tabs 42 are typically utilized, two on each side edge 32′. It is further notable that the cover portion 28′ of a jewel case typically has raised features 43 (FIG. 12) at the pivot and outer ends of the inner surface 41 which prevent printed literature from sliding out when seated against the inner surface 41.

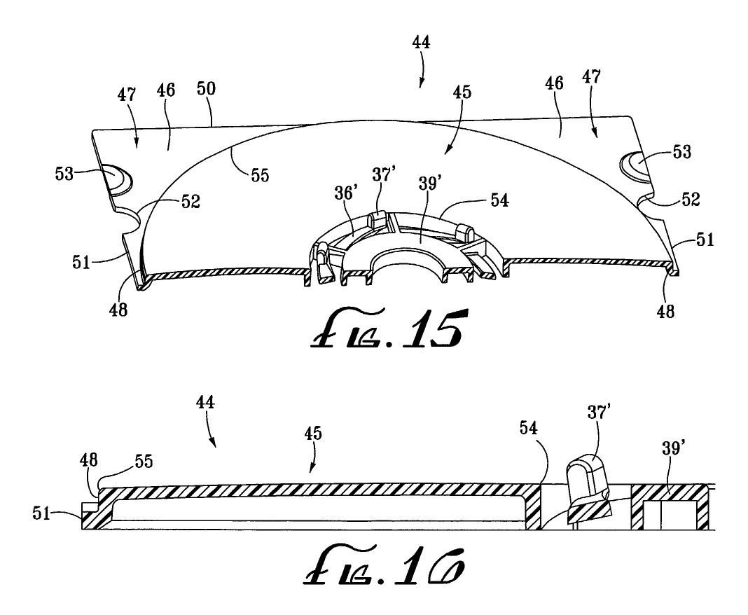

As shown in FIGS. 12-16, the jewel case insert 44 is generally planar in shape and is dimensioned to be mounted on the cover portion 28′ of a conventional jewel case. In particular, the insert 44 has a central press portion with a press surface 45. The press portion is positioned adjacent the inner surface 41 of the cover portion 28′ such that the press surface 45 faces up and away from the cover portion 28′. Preferably, the press surface 45 has an annular configuration with an inner circumference 54 and an outer circumference 55. And as can be seen in FIGS. 15 and 16 in particular, the press surface 45 has a radial cross-section which preferably generally increases in relative elevation from the outer circumference 55 to the inner circumference 54. It is appreciated that this includes both continuous as well as step increases in elevation. Preferably still, as shown in FIG. 16, the radial cross-section of the press surface 45 has a convex-curvilinear shape. In any event, the press surface 45 operates to exert contact pressure to an annular label in order to transfer it to a compact disc, as will be discussed in detail below. For this purpose, it is notable that the press portion, as well as the insert 44 as a whole, is constructed from an injection molded plastic such as polyethylene or polypropylene which exhibits some resiliently biasing characteristics. Some resilient biasing of the press surface 45 is believed to provide more even application of contact pressure to annular labels during the transfer process.

The jewel case insert 44 also has label retaining means for temporarily retaining an annular label against the press surface 45 with the self-adhesive side 16 up and facing away from the press surface 45. Preferably, as shown in the figures, the label retaining means is located within the inner circumference 54 of the annular press surface 45, and preferably has a hub/spoke configuration integrally connected to the press portion. The hub spoke configuration includes a hub 39′ and at least two fingers 36′ which each extend from a fixed end to a suspended end. As discussed previously, the fixed end of each finger 36′ is preferably transversely secured to a corresponding spoke, but is not limited only to such configuration. And the suspended end is preferably adapted to lightly contact the inner circumference edge of the annular label 15 in a resiliently biasing manner. Moreover, the fingers 36′ also preferably have shoes 37′ at its suspended ends which actually effect contact with the inner circumference edge 18 of the annular label 15.

And as can be seen in the figures, a shoulder 46 is connected to the press portion which extends beyond the outer circumference 55 of the press surface 45 in a radial direction. The shoulder 46 has an outer edge 50, a pair of side edges 51, and an inner edge 49, which are dimensioned to fit within the boundaries of the inner surface, i.e. the second outer edge 35′, the two opposing side edges 32′, and the second pivot edge 31′. As can be best seen in FIGS. 15 and 16, the shoulder 46 preferably connects to an annular step sidewall 48 of the press portion which elevates the press surface 45 above the shoulder 46. It is appreciated that while the shoulder 46 is shown in the figures as a single surface construction continously surrounding the press surface 45, it is not limited only to such. Alternatively, a plurality of independent shoulder portions may be utilized as well. In any case, the shoulder 46 operates to releaseably engage the guide tabs 42 to thereby maintain the press portion adjacent the inner surface 41 of the cover portion 28′ with the press surface 45 facing up and away from the cover portion 28′. It is notable that the terms “engage” and “engaging” as used herein and in the claims, are not necessarily limited to a state of continuous contact between bodies. Rather it is broadly defined to describe a confrontational state where bodies may be in physically contact, or are poised and ready to contact, affect, or interact with each other. It is therefore understood that the term “shoulder means for releasably engaging the guide tabs” includes both a contactual relationship, as well as a state of spaced-apart confrontation where the guide tabs 42 are positioned to obstruct release of the shoulder 46, especially in a direction normal to the inner surface 41 of the cover portion 28′. It is appreciated that even without constant contact between the guide tabs 42 and the shoulder 46, the guide tabs 42 obstruct the release of the shoulder 46 therepast, thereby producing an “engagement” therebetween.

As shown in the figures, the shoulder 46 preferably has a plurality of guide tab contact surfaces 53 which abuttingly engage the guide tabs 42 from between the guide tabs 42 and the inner surface 41 of the cover portion 28′. The guide tab contact surfaces 53 are preferably raised portions of the shoulder 64 which align beneath the guide tabs 42 when fully seated (see FIG. 12). Moreover, each guide tab contact surface 53 preferably has an incline portion which wedges the guide tab contact surface 53 between the corresponding guide tab 42 and the inner surface 41, when moved between an initial drop-loaded position (shown in FIG. 14) and a fully seated operational position (shown in FIG. 15). It is appreciated that the wedging action provides a snug frictional engagement to better maintain the insert 44 in the seated position. It is further appreciated that the guide tab contact surfaces 53 are particularly located on the shoulder 46 such that they concentrically align an annular label 15 to a compact disc 11 when the insert 44 is fully mounted in the seated position and the jewel case is pivoted to the closed position.

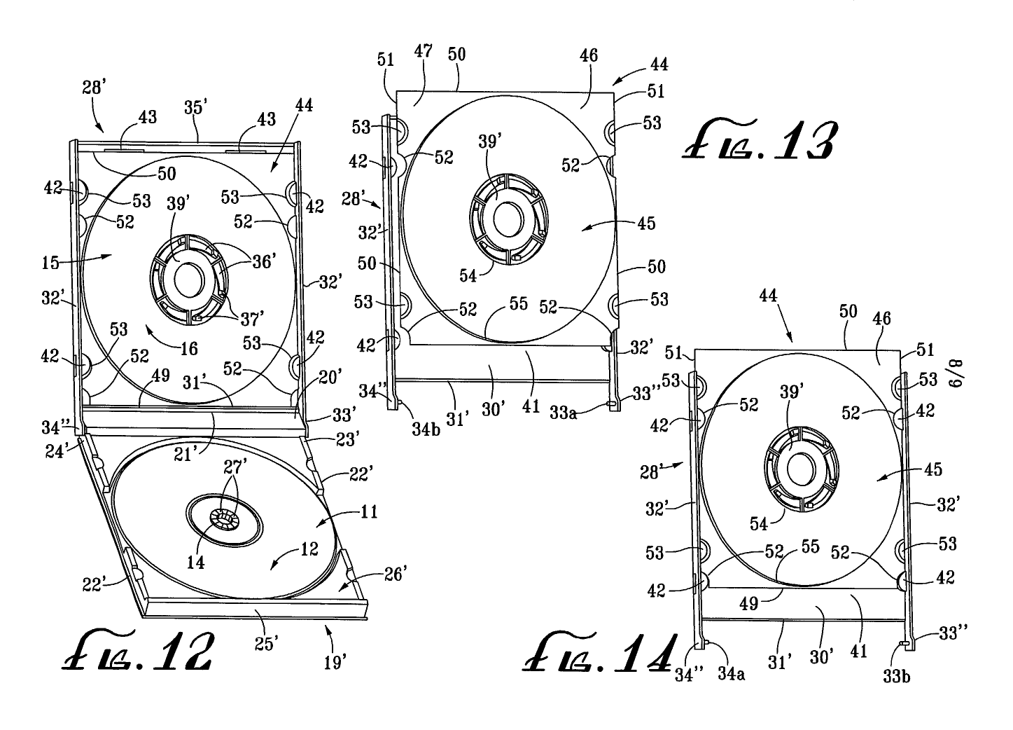

Furthermore, as can be seen in FIGS. 12-15, the shoulder 46 has a plurality of notches 52 which operate to facilitate insertion and mounting of the jewel case insert 44 on the cover portion 28′. Preferably, each notch 52 is associated with and positioned adjacent a corresponding guide tab contact surface 53. And each notch 52 is sized and positioned to allow passage of a corresponding guide tab 42 therethrough. As shown in FIG. 13, the insert 44 may be positioned over the inner surface 41 of the cover portion 28′ with the notches 52 aligned to receive passage of the guide tabs 42. Next, as shown in FIG. 14, the insert 44 may be drop-loaded against the inner surface 41 such that the guide tabs 42 pass through the notches 52 and thereby position the corresponding guide tab contact surface 53 at a slide level. The slide level is that elevation relative to the inner surface 41 and the guide tabs 42 where the guide tab contact surfaces 53 may slide between the guide tabs 42 and the inner surface 41 to engage the guide tabs 42. In this manner, the insert 44 may be subsequently slid to the seated position shown in FIG. 12 where the outer edge 50 clears past the raised features 43 and the annular press surface 45 is positioned to concentrically transfer an annular label to a compact disc.

And upon seatably mounting the jewel case insert 44, an annular label 15 may be temporarily retained, a compact disc 11 releasably mounted, and the cover 28′ and base 19′ portions pivoted relative to each other. When pivoted to the closed position, the press surface 45 exerts a contact pressure on the annular label 15 such that all regions of the self-adhesive side adheres to the compact disc 11, and the label is transferred thereto. It is notable that the the convex curvilinear cross-section of the press surface 45 as shown in FIGS. 15 and 16 operates to roll-press the annular label against the compact disc, similar in operation to that of a grindstone wheel. It is believed that this roll-pressing configuration and action more completely and evely applies contact pressure over the annular label during application and tranfer.

The present embodiments of this invention are thus to be considered in all respects as illustrative and not restrictive; the scope of the invention being indicated by the appended claims rather than by the foregoing description. All changes which come within the meaning and range of equivalency of the claims are intended to be embraced therein.

I claim:

1. A jewel case insert for applying an annular label with a self-adhesive side to a compact disc, said jewel case insert for use with a jewel case of the type having (1) a base portion with a compact disc support surface and means for releasably mounting a compact disc thereon, and (2) a cover portion hingedly connected to the base portion for hinging between open and closed positions, the cover portion having an inner surface which confronts the compact disc support surface when in the closed position, and a plurality of guide tabs which extend inwardly in spaced relation to the inner surface, said jewel case insert comprising:
a press portion having a press surface;
label retaining means for temporarily retaining an annular label against the press surface with the self-adhesive side up; and
shoulder means connected to the press portion for releasably engaging the plurality of guide tabs to maintain the press portion adjacent the inner surface of the cover portion with the press surface facing up,
wherein, in the closed position, a temporarily retained annular label is concentrically aligned with a releasably mounted compact disc and the press surface abuts the annular label against the compact disc to transfer it thereto.

2. The jewel case insert as in claim 1,
wherein the shoulder means includes a plurality of guide tab contact surfaces for abuttingly engaging the plurality of guide tabs from between the guide tabs and the inner surface of the cover portion.

3. The jewel case insert as in claim 2,
wherein the shoulder means includes a plurality of notches for enabling passage of the plurality of guide tabs therethrough to thereby position the plurality of guide tab contact surfaces at a slide level where the guide tab 33 contact surfaces may slide between the guide tabs and the inner surface of the cover portion to abuttingly engage the guide tabs.

4. The jewel case insert as in claim 2,
wherein each guide tab contact surface has an incline portion which wedges the guide tab contact surface between a corresponding guide tab and the inner surface of the cover portion.

5. The jewel case insert as in claim 1,
wherein the press surface has an annular configuration with inner and outer circumferences.

6. The jewel case insert as in claim 5,
wherein the press surface has a radial cross-section which generally increases in relative elevation from the outer to inner circumferences.

7. The jewel case insert as in claim 6,
wherein the radial cross-section of the press surface has a convex-curvilinear shape.

8. The jewel case insert as in claim 5,
wherein the press surface has a convex-curvilinear radial cross-section between the inner and outer circumferences.

9. The jewel case insert as in claim 5,
wherein the means for temporarily retaining the annular label is positioned within the inner circumference.

10. A jewel case insert for applying an annular label with a self-adhesive side to a compact disc, said jewel case insert for use with a jewel case of the type having (1) a base portion with a compact disc support surface and means for releasably mounting a compact disc thereon, and (2) a cover portion hingedly connected to the base portion for hinging between open and closed positions, the cover portion having an inner surface which confronts the compact disc support surface when in the closed position, and a plurality of guide tabs which extend inwardly in spaced relation to the inner surface, said jewel case insert comprising:
a press portion having a press surface;
label retaining means for temporarily retaining an annular label against the press surface with the self-adhesive side up; and
a plurality of shoulder portions connected to the press portion, each shoulder portion including a guide tab contact surface for releasably abutting a corresponding guide tab from between the guide tab and the inner surface of the cover portion, for maintaining the press portion adjacent the inner surface of the cover portion with the press surface facing up,
wherein, in the closed position, a temporarily retained annular label is concentrically aligned with a releasably mounted compact disc and the press surface abuts the annular label against the compact disc to transfer it thereto.

11. The jewel case insert as in claim 10,
wherein each shoulder portion includes a notch for enabling passage of a corresponding guide tab therethrough to thereby position the corresponding guide tab contact surface at a slide level where the guide tab contact surface may slide between the guide tab and the inner surface of the cover portion to abut the guide tab.

12. The jewel case insert as in claim 10,
wherein each guide tab contact surface has an incline portion which wedges the guide tab contact surface between a corresponding guide tab and the inner surface of the cover portion.

13. The jewel case insert as in claim 10,
wherein the press surface has an annular configuration with inner and outer circumferences.

14. The jewel case insert as in claim 13,
wherein the press surface has a radial cross-section which generally increases in relative elevation from the outer to inner circumferences.

15. The jewel case insert as in claim 14,
wherein the radial cross-section of the press surface has a convex-curvilinear shape.

16. The jewel case insert as in claim 13,
wherein the press surface has a convex-curvilinear radial cross-section between the inner and outer circumferences.

17. The jewel case insert as in claim 13,
wherein the means for temporarily retaining the annular label is positioned within the inner circumference.

18. A labeling apparatus for applying an annular label with a self-adhesive side to a compact disc, said labeling apparatus comprising:
a base portion with a compact disc support surface and means for releasably mounting a compact disc thereon;
a cover portion hingedly connected to the base portion for hinging between open and closed positions, the cover portion having an annular press surface which confronts the compact disc support surface when in the closed position, and label retaining means for temporarily retaining an annular label against the annular press surface with the self-adhesive side up, the annular press surface having an inner circumference, an outer circumference, and a radial cross-section which generally increases in relative elevation from the outer to inner circumferences,
wherein, in the closed position, a temporarily retained annular label is concentrically aligned with a releasably mounted compact disc and the press surface abuts the annular label against the compact disc to transfer it thereto.

19. The labeling apparatus as in claim 18,
wherein the radial cross-section of the press surface has a convex-curvilinear shape.

20. The jewel case insert as in claim 18,
wherein the means for temporarily retaining the annular label is positioned within the inner circumference.
